(19) United States
(12) Patent Application Publication
(10) Pub. No.: US 2026/0038924 A1
(43) Pub. Date: Feb. 5, 2026

(54) BATTERY CELL AND METHOD OF MANUFACTURING SEAL GASKET

(71) Applicant: SK ON CO., LTD., Seoul (KR)

(72) Inventor: Hoemin CHEONG, Daejeon (KR)

(21) Appl. No.: 19/250,085

(22) Filed: Jun. 26, 2025

(30) Foreign Application Priority Data
Jul. 31, 2024 (KR) 10-2024-0101566

(51) Int. Cl. H01M 50/193; B29C 45/14; B29C 45/16; B29L 31/26; B29L 31/34; H01M 50/107; H01M 50/152; H01M 50/184; H01M 50/186

(52) U.S. Cl. CPC H01M 50/193; H01M 50/107; H01M 50/152; H01M 50/184; H01M 50/186; B29C 45/14065; B29C 45/16; B29L 2031/265; B29L 2031/3468

(57) ABSTRACT

A battery cell includes an electrode assembly; a case in which the electrode assembly is accommodated; a current collector plate electrically connected to an electrode tab of the electrode assembly; and a cap assembly sealing the case, wherein the cap assembly includes a cap plate sealing an opening of the case; and a seal gasket insulating the cap plate and the case from each other, wherein the seal gasket includes a body portion and a coating portion covering the surface of the body portion, wherein the body portion and the coating portion are formed of different materials, and wherein the coating portion is formed of a material having a greater degree of elasticity than that of the body portion.

### CROSS-REFERENCE TO RELATED APPLICATION(S)

This application claims benefit of priority to Korean Patent Application No. 10-2024-0101566 filed on Jul. 31, 2024 in the Korean Intellectual Property Office, the disclosure of which is incorporated herein by reference in its entirety.

### TECHNICAL FIELD

The present disclosure generally relates to a battery cell which may be charged and discharged and a method of manufacturing a seal gasket.

### BACKGROUND

A secondary battery cell has attracted attention as a power source for various mobile devices and electric vehicles as a secondary battery is convenient in that a secondary battery may be charged and discharged, unlike a primary battery.

A secondary battery cell may be manufactured as a pouch-type cell or a can-type cell. A pouch-type cell may have a structure in which an electrode assembly is accommodated in a cell case (pouch) having flexibility. A can-type cell may have a structure in which an electrode assembly is accommodated in a cell case (can) having rigidity, and may be configured as a cylindrical cell, a square cell, a coin-type cell, or the like.

### SUMMARY

In a general battery cell, a cap plate and a can may be sealed using a seal gasket of which an external surface is coated with tar to prevent leakage of materials from the can. When the seal gasket is coated with tar, tar may melt or powder may be generated in an environment of 30° C. or higher, such that the manufacturing environment may be contaminated.

An aspect of the present disclosure is to provide a battery cell which may prevent contamination by tar coating, and a method of manufacturing a seal gasket.

An aspect of the present disclosure is to provide a battery cell having improved performance in preventing leakage, and a method of manufacturing a seal gasket.

A battery cell and a method of manufacturing a seal gasket may be widely applied to green technology fields such as an electric vehicle, a battery charging station, and a solar power generation and wind power generation using batteries. Also, the battery cell of the present disclosure may be used in an eco-friendly electric vehicle, a hybrid vehicle, or the like, to ameliorate the effects of climate change by suppressing air pollution and greenhouse gas emissions.

According to an aspect of the present disclosure, a battery cell includes an electrode assembly; a case in which the electrode assembly is accommodated; a current collector plate electrically connected to an electrode tab of the electrode assembly; and a cap assembly sealing the case, wherein the cap assembly includes a cap plate sealing an opening of the case; and a seal gasket insulating the cap plate and the case from each other, wherein the seal gasket includes a body portion and a coating portion covering the surface of the body portion, wherein the body portion and the coating portion are formed of different materials, and wherein the coating portion is formed of a material having a greater degree of elasticity than that of the body portion.

The coating portion includes at least one of silicone, high density polyethylene (HDPE), or perfluoroalkoxy alkane (PFA).

The body portion includes at least one of poly butylene terephthalate (PBT), poly carbonate (PC), or poly propylene (PP).

A surface of the body portion includes an internal surface having at least a portion in contact with the cap plate; an external surface having at least a portion in contact with the case; and a side surface surrounding at least a portion of a surface between the external surface and the internal surface, and wherein the coating portion includes a first coating portion covering the internal surface; and a second coating portion covering the external surface.

The coating portion further includes a third coating portion covering the side surface.

The first coating portion, the second coating portion and the third coating portion are integrated with each other.

According to an aspect of the present disclosure, a method of manufacturing a seal gasket includes a body portion injection process of manufacturing a body portion of a seal gasket; and a double-injection process of double-injecting a coating portion into the body portion injected by the body portion injection process.

The double-injection process includes a body portion mounting process of mounting the body portion injected by the body portion injection process on a first mold frame; a second mold frame stacking process of stacking a second mold frame on the first mold frame on which the body portion is mounted by the body portion mounting process; a resin injecting process of injecting resin of the coating portion into an internal space having a shape of the coating portion formed by stacking the second mold frame on the first mold frame by the second mold frame stacking process; a resin curing process of curing resin of the coating portion injected by the resin injecting process and forming a seal gasket; and a seal gasket removal process of removing the second mold frame and taking out the seal gasket from the first mold frame after the seal gasket is formed by the resin curing process.

The coating portion is formed of a material having a greater degree of elasticity than that of the body portion.

The body portion includes at least one of poly butylene terephthalate (PBT), poly carbonate (PC), or poly propylene (PP).

Resin of the coating portion injected in the resin injecting process includes at least one of silicone, high density polyethylene (HDPE), or perfluoroalkoxy alkane (PFA).

### BRIEF DESCRIPTION OF DRAWINGS

Predetermined aspects, features, and advantages of the present disclosure are illustrated by the following detailed description with reference to the accompanying drawings.

FIG. 1 is a perspective diagram illustrating a battery cell according to an embodiment of the present disclosure;

FIG. 2 is a cross-sectional diagram taken along line I-I′ in FIG. 1;

FIG. 3 is an enlarged diagram illustrating portion A in FIG. 2;

FIG. 4 is a perspective diagram illustrating a seal gasket according to an embodiment of the present disclosure;

FIG. 5 is a cross-sectional diagram taken along line II-II′ in FIG. 4;

FIG. 6 is a cross-sectional diagram illustrating a modified embodiment of the seal gasket illustrated in FIG. 4;

FIG. 7 is a diagram illustrating a state before a device for manufacturing a seal gasket is coupled according to an embodiment of the present disclosure;

FIG. 8 is a diagram illustrating a state after a device for manufacturing a seal gasket is coupled according to an embodiment of the present disclosure;

FIG. 9 is a flowchart illustrating a method of manufacturing a seal gasket according to an embodiment of the present disclosure; and

FIG. 10 is a flowchart illustrating a double-injection process of a method of manufacturing a seal gasket according to an embodiment of the present disclosure.

### DETAILED DESCRIPTION

The embodiments of the present disclosure are illustrated in embodiments with reference to the accompanying drawings.

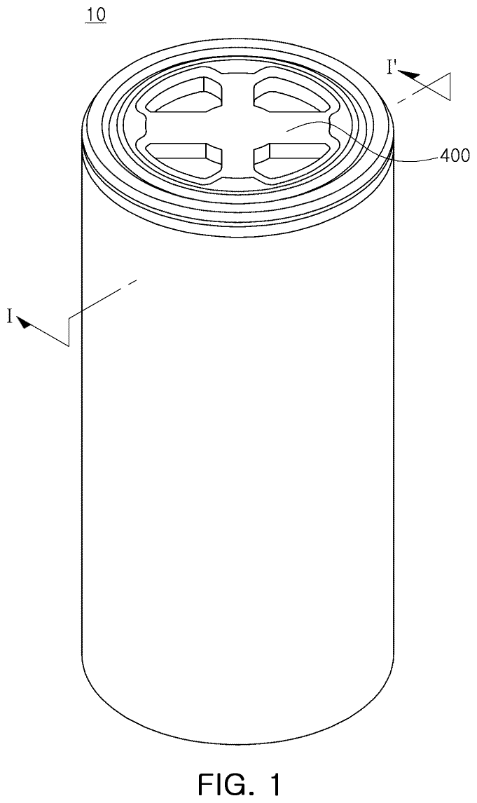

FIG. 1 is a perspective diagram illustrating a battery cell according to an embodiment.

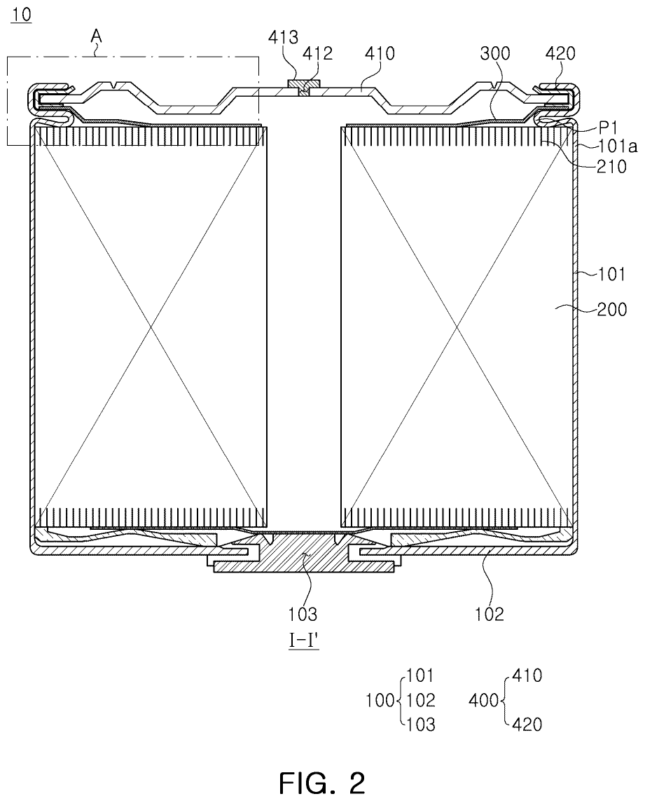

FIG. 2 is a cross-sectional diagram taken along line I-I′ in FIG. 1.

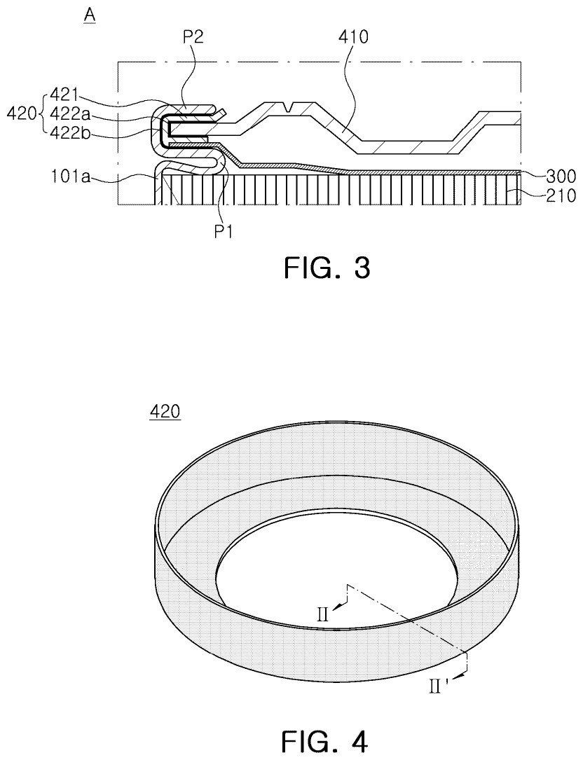

FIG. 3 is an enlarged diagram illustrating portion A in FIG. 2.

Referring to FIGS. 1 to 3, a battery cell 10 according to an embodiment may include an electrode assembly 200, a case 100 in which the electrode assembly 200 is accommodated.

The electrode assembly 200 may include a positive electrode plate, a negative electrode plate, and a separator. The separator may be formed of an insulating material interposed between the negative electrode plate and the positive electrode plate. The electrode assembly 200 may be configured as a stack type in which the positive electrode plate, the negative electrode plate, and the separator are alternately stacked. Alternatively, the electrode assembly 200 may be configured as a jelly roll type in which the positive electrode plate, the negative electrode plate, and the separator interposed between the positive electrode plate and the negative electrode plate are alternately stacked and wound in a roll shape. In embodiments, the electrode assembly 200 is illustrated as being a jelly roll type, but an example embodiment thereof is not limited thereto.

The positive electrode plate and the negative electrode plate may have a structure in which a positive electrode active material or a negative electrode active material is coated on the foil. For example, the negative electrode plate may be formed by coating graphite, or the like, on a foil of copper or nickel material, and the positive electrode plate may be formed by coating a transition metal oxide active material on a foil of aluminum material.

The electrode assembly 200 may include an electrode tab 210. The electrode tab 210 may indicate a negative electrode tab, and vice versa. At least a portion of the positive electrode plate and the negative electrode plate may not be coated with an active material. A portion of the region of the positive electrode plate and the negative electrode plate, which is not coated with the active material may indicate an uncoated portion. The uncoated portions may protrude upwardly and downwardly, respectively. That is, the protruding uncoated portions of the positive electrode plate and the negative electrode plate may work as the electrode tab 210.

The electrode tab 210 and the current collector plate 300 may be in contact with and electrically connected to each other, and may be coupled to each other by welding such as ultrasonic welding, laser welding, or the like. However, the method of coupling the electrode tab 210 to the current collector plate 300 is not limited thereto.

The case 100 may accommodate the electrode assembly 200. In other words, the electrode assembly 200 may be accommodated in the case 100.

The case 100 may include a sidewall 101 forming an accommodation space therein, and a lower plate 102 having a through-hole 103 formed therein. The accommodation space may be formed by the sidewall 101 and the lower plate 102 of the case 100. The case 100 may have a cylindrical shape with one side open. The case 100 may have a hollow cylindrical shape including a circular cross-section.

The sidewall 101 may have a tube shape, and the lower plate 102 may have a plate shape covering a bottom side of the accommodation space. The sidewall 101 may have a circular tube shape. The lower plate 102 may have a flat plate shape. In the case 100, thicknesses of the lower plate 102 and the sidewall 101 may be varied. For example, the lower plate 102 and the sidewall 101 may have the same thickness, and the thickness of the lower plate 102 may have a value larger than that of the thickness of the sidewall 101. The case 100 may include a metal material such as aluminum or an aluminum alloy, but the material of the case 100 may be varied.

The sidewall 101 and the lower plate 102 of the case 100 may be integrated with each other. For example, the case 100 may be manufactured in a shape in which the sidewall 101 and the lower plate 102 are integrally formed by deep-drawing a metal sheet. When the case 100 is integrated, a process of bonding the sidewall 101 to the lower plate 102 is not necessary, such that manufacturing of the case 100 and/or the battery cell 10 may be easily performed and workability may be improved.

However, the case 100 in an embodiment is not limited to the configuration in which the sidewall 101 and the lower plate 102 are integrated, and the sidewall 101 and the lower plate 102 may be manufactured separately and may be coupled or joined to each other by welding, or the like.

The battery cell 10 according to an embodiment may include a cap assembly 400 for sealing the case 100. The cap assembly 400 may include a cap plate 410 covering a top side of the accommodation space of case 100. The cap plate 410 may cover the accommodation space on the opposite side to the lower plate 102. That is, the cap plate 410 may seal an opening of the case 100.

The cap plate 410 may be coupled to the sidewall 101 of the case 100 by crimping, welding, or the like. As an example, a beading portion P1 may be formed by beading the open end 101a of the sidewall 101 of the case 100, and while the cap plate 410 is disposed on the beading portion P1, by crimping the end 101a of the sidewall 101 and the cap plate 410, the crimping portion P2 may be formed. Alternatively, the cap plate 410 may also be coupled to the end 101a of the sidewall 101 by welding.

An injection port 412 for injecting an electrolyte into the interior of the case 100 may be formed on the cap plate 410. The injection port 412 may be formed in the center of the body 411 of the cap plate 410, and the position and size thereof may be varied. The injection port 412 may be sealed with an injection port stopper 413 after the electrolyte is injected.

The cap assembly 400 may include a seal gasket 420 insulating the cap plate 410 and the case 100 from each other. The seal gasket 420 may be disposed between the cap plate 410 and the sidewall 101 of the case 100 for sealing. The seal gasket 420 may work as a sealing member for sealing a region between the cap plate 410 and the sidewall 101.

The battery cell 10 according to an embodiment may include a current collector plate 300 electrically connected to an electrode tab 210 of an electrode assembly 200. A lower surface of the current collector plate 300 may be configured to be joined to or to be in contact with the electrode tab 210 so as to be electrically connected to the electrode tab 210. Welding may be used to join the current collector plate 300 to the electrode tab 210. For example, the current collector plate 300 and the electrode tab 210 may be joined to each other by ultrasonic welding, laser welding, resistance welding, or the like. Alternatively, the current collector plate 300 and the electrode tab 210 may be electrically connected while being in contact with each other without being joined to each other.

The current collector plate 300 may be electrically connected to at least one of the cap plate 410 or the sidewall 101 of the case 100. In this case, the cap plate 410 and the case 100 may have polarity. For example, when the electrode tab 210 is a negative electrode tab, the cap plate 410 and the case 100 may be charged as a negative electrode. The object electrically connected to the current collector plate 300 may be varied depending on design specifications of the battery cell 10.

FIG. 4 is a perspective diagram illustrating a seal gasket according to an embodiment.

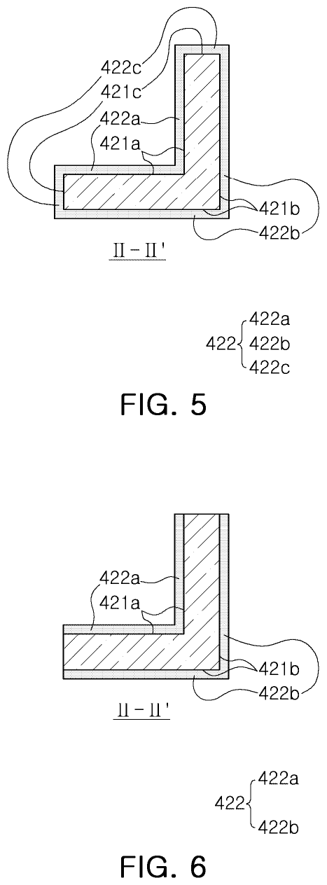

FIG. 5 is a cross-sectional diagram taken along line II-II′ in FIG. 4.

FIG. 6 is a cross-sectional diagram illustrating a modified embodiment of the seal gasket illustrated in FIG. 4.

The description of the current collector plate 300, the cap plate 410 and the seal gasket 420 in FIGS. 1 to 3 may be applied to the current collector plate 300, the cap plate 410 and the seal gasket 420 in FIGS. 4 to 6.

Referring to FIGS. 4 to 6 together with FIG. 3, a seal gasket 420 according to an embodiment may include a body portion 421 and a coating portion 422 covering at least a portion of a surface of the body portion 421. In this case, the body portion 421 and the coating portion 422 may be formed of different materials. The body portion 421 may not need to be tar-coat due to the coating portion 422, and contamination of the manufacturing environment caused by powder generated from the tar coating may be prevented. Also, contamination caused by tar melting in an environment of 30° C. or higher may be prevented.

The coating portion 422 may be formed of a material having a greater degree of elasticity than that of the body portion 421. Accordingly, sealing ability of the seal gasket 420 may be improved. In this case, the material having elasticity may include at least one of silicone, high density polyethylene (HDPE), or perfluoroalkoxy alkane (PFA). That is, the coating portion 422 may include at least one of silicone, HDPE, or PFA.

The body portion 421 may include at least one of poly butylene terephthalate (PBT), poly carbonate (PC), or poly propylene (PP), which is a material having rigidity higher than rigidity of the coating portion 422. In other words, the body portion 421 may include at least one of PBT, PC, or PP.

According to an embodiment, the surface of the body portion 421 may include an internal surface 421a in contact with at least a portion of the cap plate 410, an external surface 421b in contact with the sidewall 101 of the case 100, and a side surface 421c surrounding at least a portion of the surface between the internal surface 421a and the external surface 421b in a state in which the seal gasket 420 seals a region between the cap plate 410 and the sidewall 101 of the case 100.

According to an embodiment, the coating portion 422 may include a first coating portion 422a covering the internal surface 421a, and a second coating portion 422b covering the external surface 421b. According to an embodiment, the coating portion 422 may further include a third coating portion 422c covering the side surface 421c. In this case, the first coating portion 422a, the second coating portion 422b and the third coating portion 422c may be integrated with each other.

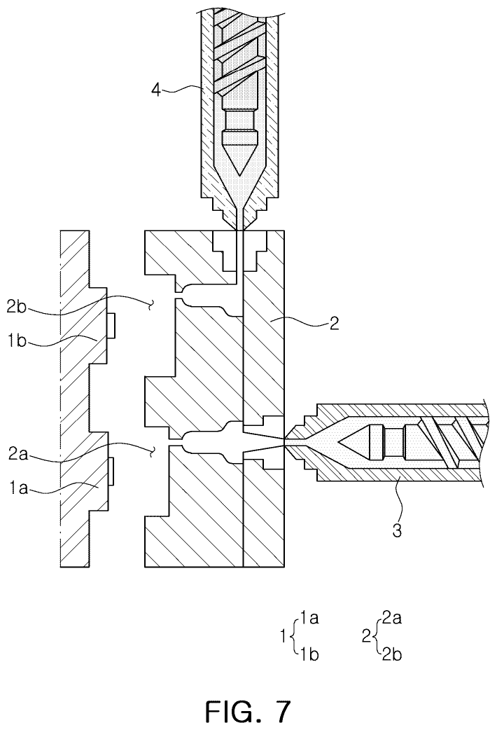

FIG. 7 is a diagram illustrating a state before a device for manufacturing a seal gasket is coupled according to an embodiment.

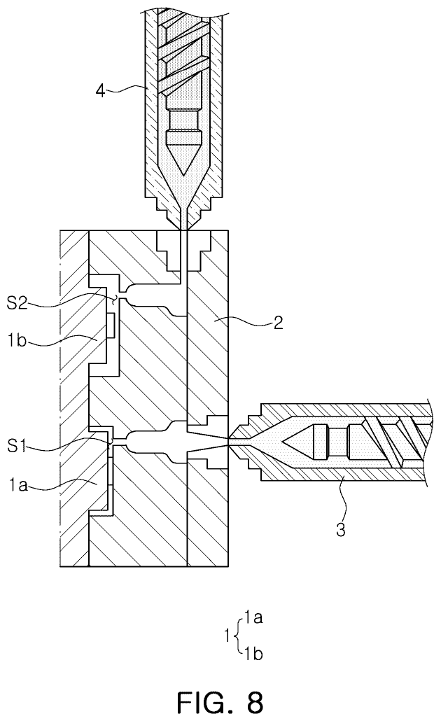

FIG. 8 is a diagram illustrating a state after a device for manufacturing a seal gasket is coupled according to an embodiment.

The description of the body portion 421 and the coating portion 422 of the seal gasket 420 described in FIGS. 4 to 6 may also be applied to the body portion 421 and the coating portion 422 of the seal gasket 420 in FIG. 7.

Referring to FIG. 7, a double-injection device for manufacturing a seal gasket 420 according to an embodiment may include a first mold frame 1 and a second mold frame 2 forming an internal space S1 having a shape of the body portion and an internal space S2 having a shape of the coating portion, a first injection unit 3 accommodating resin of the body portion and injecting resin of the body portion into the internal space S1 having the shape of the body portion, and a second injection unit 4 accommodating resin of the coating portion and injecting the resin of the coating portion into the internal space S2 having the shape of the coating portion.

The first mold frame 1 may include a first protrusion 1a and a second protrusion 1b. The second mold frame 2 may include a first concave portion 2a and a second concave portion 2b. The first mold frame 1 and the second mold frame 2 may form a coupling lower surface, the first protrusion 1a and the first concave portion 2a may form the internal space S1 having the shape of the body portion, and the second protrusion 1b and the second concave portion 2b may form the internal space S2 having the shape of the coating portion.

A double-injection device for manufacturing a seal gasket 420 may inject-mold the body portion 421 and the coating portion 422 using different resins. In this case, the resin of the body portion 421 may include at least one of PBT, PC, or PP, and the resin of the coating portion 422 may include at least one of silicone, HDPE, or PFA. When the body portion 421 is formed of a material having rigidity higher than that of the coating portion 422, and the coating portion 422 is formed of a material having elasticity higher than that of the body portion 421, a seal gasket 420 having improved durability and sealing ability may be provided. Also, the surface of the body portion 421 may not need to be tar coated, such that contamination occurring during the manufacturing process may be reduced.

The first injection unit 3 may accommodate resin of the body portion 421 including at least one of PBT, PC, or PP, and may inject the resin of the body portion 421 into the internal space S1 having the shape of the body portion. The first injection unit 3 may be disposed more adjacent to the internal space S1 having the shape of the body portion than the second injection unit 4.

The second injection unit 4 may accommodate resin of the coating portion 422 including at least one of silicone, HDPE or PFA, and may inject the resin of the coating portion 422 into the internal space S2 having the shape of the coating portion. The second injection unit 4 may be disposed more adjacent to the internal space S2 having the shape of the coating portion than the first injection unit 3.

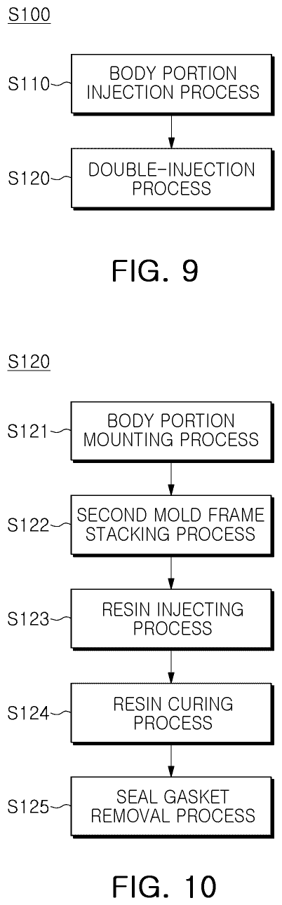

FIG. 9 is a flowchart illustrating a method of manufacturing a seal gasket according to an embodiment.

FIG. 10 is a flowchart illustrating a double-injection process of a method of manufacturing a seal gasket according to an embodiment.

The description of the body portion 421 and the coating portion 422 of the seal gasket 420 described in FIGS. 4 to 6 may also be applied to the body portion 421 and the coating portion 422 of the seal gasket 420 in FIGS. 9 and 10.

Referring to FIGS. 9 and 10 together with FIG. 7, a method of manufacturing a seal gasket (S100) according to an embodiment may include a body portion injection process (S110) of injecting the body portion 421 of the seal gasket 420, and a double-injection process (S120) of double-injecting the coating portion 422 into the body portion 421 injected by the body portion injection process (S110).

The body portion 421 may be injected in the body portion injection process (S110). The first mold frame 1 and the second mold frame 2 may be coupled to each other and may form an internal space S1 having a shape of a body portion 421 and an internal space S2 having a shape of a coating portion. The first injection unit 3 may inject a body portion resin into the internal space S1 having the shape of the body portion in the body portion injection process (S110). The body portion 421 may be injected by curing the resin of the injected body portion.

The double-injection process (S120) according to an embodiment may include a body portion mounting process (S121) of mounting the body portion 421 injected by the body portion injection process (S110) on the first mold frame 1, a second mold frame stacking process (S122) of stacking the second mold frame 2 on the first mold frame 1 on which the body portion 421 is mounted by the body portion mounting process (S121), a resin injecting process (S123) of injecting resin of the coating portion into the internal space S2 having the shape of the coating portion 422 formed by stacking the second mold frame 2 on the first mold frame 1 by the second mold frame stacking process (S122), a resin curing process (S124) of curing resin of the coating portion injected by the resin injecting process (S123) and forming the seal gasket 420, and a seal gasket removal process (S125) of, when seal gasket 420 is molded by the resin curing process S124, removing the second mold frame 2 and taking out the seal gasket 420 from the first mold frame 1.

In the body portion mounting process (S121), the body portion 421 injected by the body portion injection process (S110) may be mounted on the second protrusion 1b of the first mold frame 1.

In the second mold frame stacking process (S122), the second mold frame 2 may be stacked on the first mold frame 1 on which the body portion 421 is mounted by the body portion mounting process (S121). In this case, the second concave portion 2b of the second mold frame 2 may have a partial shape of the coating portion 422.

In the resin injecting process (S123), resin of the coating portion may be injected into the internal space S2 of the coating portion formed by stacking the second mold frame 2 on the first mold frame 1 by the second mold frame stacking process (S122). In this case, the resin of the coating portion may have elasticity higher than that of the resin of the body portion. In other words, the coating portion may be formed of a material having elasticity higher than that of the body portion. For example, the resin of the body portion injected into the internal space S1 having a shape of the body portion may include at least one of PBT, PC, or PP, and the resin of the coating portion injected into the internal space having the shape of the coating portion may include at least one of silicone, HDPE, or PFA. The injection of the resin of the coating portion may be performed by the second injection unit 4.

In the resin curing process (S124), the resin of the coating portion injected into the space of the shape of the coating portion 422 by the resin injecting process (S123) may be cured and the seal gasket 420 may be formed.

In the seal gasket removal process (S125), when the seal gasket 420 is formed by the resin curing process (S124), the second mold frame 2 may be removed and the seal gasket may be taken out from the first mold frame 1.

As the seal gasket 420 is formed by double-injecting an elastic material into the surface of the body portion 421, sealing performance may be improved as compared to a general seal gasket. Also, the tar coating on the surface of the seal gasket 420 may not be performed. By not performing the tar coating, contamination generated from the tar coating may be prevented, thereby maintaining a clean manufacturing environment.

According to the aforementioned embodiments, contamination by tar coating may be prevented.

Also, performance of preventing leakage may be improved.

Only specific examples of implementations of predetermined embodiments are described. Variations, improvements and enhancements of the disclosed embodiments and other embodiments may be made with respect to the disclosure of this patent document.

What is claimed is:

1. A battery cell, comprising:
an electrode assembly;
a case in which the electrode assembly is accommodated;
a current collector plate electrically connected to an electrode tab of the electrode assembly; and
a cap assembly sealing the case,
wherein the cap assembly includes:
a cap plate sealing an opening of the case; and
a seal gasket insulating the cap plate and the case from each other,
wherein the seal gasket includes a body portion and a coating portion covering the surface of the body portion,
wherein the body portion and the coating portion are formed of different materials, and
wherein the coating portion is formed of a material having a greater degree of elasticity than that of the body portion.

2. The battery cell of claim 1, wherein the coating portion includes at least one of silicone, high density polyethylene (HDPE), or perfluoroalkoxy alkane (PFA).

3. The battery cell of claim 1, wherein the body portion includes at least one of poly butylene terephthalate (PBT), poly carbonate (PC), or poly propylene (PP).

4. The battery cell of claim 1,
wherein a surface of the body portion includes:
an internal surface having at least a portion in contact with the cap plate;
an external surface having at least a portion in contact with the case; and
a side surface surrounding at least a portion of a surface between the external surface and the internal surface, and
wherein the coating portion includes:
a first coating portion covering the internal surface; and
a second coating portion covering the external surface.

5. The battery cell of claim 4, wherein the coating portion further includes a third coating portion covering the side surface.

6. The battery cell of claim 5, wherein the first coating portion, the second coating portion, and the third coating portion are integrated with each other.

7. A method of manufacturing a seal gasket, the method comprising:
a body portion injection process of manufacturing a body portion of a seal gasket; and
a double-injection process of double-injecting a coating portion into the body portion injected by the body portion injection process.

8. The method of claim 7, wherein the double-injection process includes:
a body portion mounting process of mounting the body portion injected by the body portion injection process on a first mold frame;
a second mold frame stacking process of stacking a second mold frame on the first mold frame on which the body portion is mounted by the body portion mounting process;
a resin injecting process of injecting resin of the coating portion into an internal space having a shape of the coating portion formed by stacking the second mold frame on the first mold frame by the second mold frame stacking process;
a resin curing process of curing resin of the coating portion injected by the resin injecting process and forming a seal gasket; and
a seal gasket removal process of removing the second mold frame and taking out the seal gasket from the first mold frame after the seal gasket is formed by the resin curing process.

9. The method of claim 7, wherein the coating portion is formed of a material having a greater degree of elasticity than that of the body portion.

10. The method of claim 7, wherein the body portion includes at least one of poly butylene terephthalate (PBT), poly carbonate (PC), or poly propylene (PP).

11. The method of claim 8, wherein resin of the coating portion injected in the resin injecting process includes at least one of silicone, high density polyethylene (HDPE), or perfluoroalkoxy alkane (PFA).
